(19) United States
(12) Patent Application Publication
(10) Pub. No.: US 2025/0238185 A1
(43) Pub. Date: Jul. 24, 2025

(54) MULTI-SCREEN DISPLAY SYSTEM BASED ON LIGHTNING CHIP AND CONTROL METHOD THEREOF

(71) Applicant: SHENZHEN LONGTIME VISION TECHNOLOGY CO., LTD., Shenzhen (CN)

(72) Inventor: XUDONG LIU, Shenzhen (CN)

(21) Appl. No.: 18/581,091

(22) Filed: Feb. 19, 2024

(30) Foreign Application Priority Data
Jan. 22, 2024 (CN) 202410088553.0

(51) Int. Cl. G06F 3/14; G06F 3/147; G09G 3/34

(52) U.S. Cl. CPC G06F 3/1446; G06F 3/1438; G06F 3/147; G09G 3/3406; G09G 2320/0626; G09G 2354/00; G09G 2360/144; G09G 2370/042

(57) ABSTRACT

The present invention discloses a multi-screen display system based on lightning chips and a control method thereof. The multi-screen display system includes a control device, a first display device, and a second display device. The control device is connected to the first display device and the second display device respectively. The control device includes a first microcontroller, a first lightning chip, a detection module, and a list display module. The first microcontroller is connected to the first lightning chip, the detection module, and the list display module respectively. The first lightning chip is connected to a first DP to eDP module and a second DP to eDP module through a second lightning cable. The system has no delay and does not require an installation of a driver. A single motherboard can meet needs of multiple resolutions and high refresh rate screen.

### CROSS-REFERENCE TO RELATED APPLICATIONS

This application claims priority to Chinese Patent Application No. 202410088553.0, filed on Jan. 22, 2024, which is hereby incorporated by reference in its entirety.

### TECHNICAL FIELD

The present disclosure relates to the field of display technologies, and in particular, to a multi-screen display system based on a lightning chip and a control method thereof.

### BACKGROUND

A multi-screen display system is a computer configuration that allows a user to connect and use multiple displays to be displayed simultaneously. This system provides multiple display output interfaces, such as HDMI (High-Definition Multimedia Interface), DisplayPort, or DVI (Digital Video Interactive), as well as appropriate graphics processing capabilities, allowing the user to expand his work area and improve work efficiency; the user can configure a multi-screen display system to display different applications, files, or tasks on multiple displays, enabling more flexible multitasking processing. This extension mode allows the user to work on a larger virtual desktop without frequent window switching, thereby improving a smoothness of workflow. The multi-screen display system also supports clone mode, that is, same content is simultaneously displayed on all connected displays. This is very useful for demonstrations, training, or presentations, ensuring that all viewers can see the same image.

In the existing technology, the mainstream multi-screen solution adopts a USB graphics card solution, it requires an installation of a driver, which has high latency, and poor use experience. For screens with different resolutions, a corresponding motherboard is needed to be used together, which increases the use cost to some extent. Meanwhile, the mainstream multi-screen solutions often only display the same image. When the user needs to project different images simultaneously, the mainstream multi-screen solutions are difficult to meet the use needs. Besides, the mainstream screen projection schemes have slower transmission rates, resulting in lower image clarity of display devices and lagging when displaying multiple screens simultaneously, and reducing the user's visual experience.

### SUMMARY

In view of the technical shortcomings mentioned above, the present disclosure provides a multi-screen display system based on a lightning chip and a control method thereof to address the problems proposed in the background technology.

To achieve the above objectives, the present disclosure is implemented through the following technical solutions.

A multi-screen display system based on a lightning chip, where an input end of the multi-screen display system is connected to an input device, the multi-screen display system includes a control device, a first display device, and a second display device; the control device is connected to the first display device and the second display device, respectively; where the control device includes a first microcontroller configured to receive a detection result sent by a detection module and send it to a list display module, the first microcontroller is connected to the detection module, the list display module, and a first lightning chip, respectively; the first lightning chip configured to receive DP signal sent by the input device through a first lightning cable, and outputs it in a format of DP signal to a first DP to eDP module and a second DP to eDP module, respectively; the first lightning chip is connected to the first DP to eDP module and the second DP to eDP module through a second lightning cable; the detection module configured to detect power supply signals of various interfaces of the control device, generate the detection result when the power supply signals of the interfaces change, and send to the first microcontroller; the detection module is connected to the first microcontroller; the list display module configured to display number and status of an external device that is currently connected to the control device, the list display module is connected to the first microcontroller.

In an embodiment of the present disclosure, the control device further includes the first DP to eDP module and the second DP to eDP module; the first DP to eDP module is configured to receive a first DP signal sent by the first lightning chip through a first DP channel of the second lightning cable and convert the first DP signal into a first eDP signal, where a conversion includes adjusting data format, timing, and protocol; the first DP to eDP module is connected to the first lightning chip and a first eDP interface, respectively; the first eDP interface is connected to the detection module; the second DP to eDP module is configured to receive a second DP signal sent by the first lightning chip through a second DP channel of the second lightning cable and convert the second DP signal into a second eDP signal, where a conversion includes adjusting data format, timing, and protocol; the second DP to eDP module is connected to the first lightning chip and a second eDP interface, respectively; the second eDP interface is connected to the detection module.

In an embodiment of the present disclosure, the first display device includes a first display controller, a first display panel, and a first backlight adjustment module; the first display controller is configured to receive, decode, and process signals transmitted from the first eDP interface of the control device to a third eDP interface of the first display device through a first transmission cable, and sends decoded signal to the first display panel, the third eDP interface is connected to the first display controller; the first display controller is connected to the first display panel; the first display panel is configured to display image data decoded by the first display controller; the first backlight adjustment module is configured to sense a light intensity of an external environment and control the first display controller to adjust a screen backlight brightness of the first display panel based on light intensity of the external environment; the first backlight adjustment module is connected to the first display controller.

In an embodiment of the present disclosure, the second display device includes a second display controller, a second display panel, and a second backlight adjustment module; the second display controller is configured to receive, decode, and process signals transmitted from the second eDP interface of the control device to a fourth eDP interface of the second display device through a second transmission cable, and send decoded signal to the second display panel, the fourth eDP interface is connected to the second display controller; the second display controller is connected to the second display panel; the second display panel is configured to display image data decoded by the second display controller; the second backlight adjustment module is configured to sense the light intensity of the external environment and control the second display controller to adjust a screen backlight brightness of the second display panel based on the light intensity of the external environment; the second backlight adjustment module is connected to the second display controller.

In an embodiment of the present disclosure, the control device further includes a USB audio module and a USB transmission module; the USB audio module is configured to receive an audio signal transmitted from the input device to the first lightning chip through the first lightning cable, and transmit it to an audio device connected to the audio interface through an audio interface; the USB audio module is respectively connected to the first lightning chip and the audio interface; the audio interface is connected to the detection module; the USB transmission module is configured to receive data transmitted from the input device to the first lightning chip through the first lightning cable, and transmit it to an external device connected to the USB interface through the USB interface; the USB transmission module is respectively connected to the first lightning chip and the USB interface, and the USB interface is connected to the detection module.

The present disclosure further discloses a control method for a multi-screen display system based on a lightning chip, the control method includes the following steps:
S1. connecting a control device of the multi-screen display system to an input device, delivering power to a first lightning chip through a first lightning cable by the input device; stating a first microcontroller connected to the first lightning chip, and controlling a detection module to detect electrical signals of various interfaces of the control device;
S2. determining, by the detection module, that a first eDP interface and a second eDP interface are respectively connected to a first display device and a second display device, generating a first detection result when a power supply signal between the first eDP interface and the second eDP interface having been detected by the detection module; sending first detection result to the first microcontroller; then sending, by first microcontroller, the first detection result to a list display module;
S3, learning, by a user, that both a first display device and a second display device have been successfully connected through the list display module; sending, by the input device, a first DP signal or a second DP signal to the first lightning chip through a first DP channel of a first lightning cable; and sending, by the input device, the first DP signal or the second DP signal to the first lightning chip through a second DP channel of the first lightning cable;
S4, sending, by the first lightning chip, the first DP signal or the second DP signal to a first DP to eDP module through the first DP channel of the second lightning cable; and sending, by the first lightning chip, the first DP signal or the second DP signal to a second DP to eDP module through a second DP channel of the second lightning cable;
S5, converting, by the first DP to eDP module, received first DP signal into a first eDP signal or received second DP signal into a second eDP signal after receiving the first DP signal or the second DP signal; converting, by the second DP to eDP module, received first DP signal into the first eDP signal or received second DP signal into the second eDP signal after receiving the first DP signal or the second DP signal, where a conversion includes adjusting data format, timing and protocol;
S6, sending, by the first DP to eDP module, the first eDP signal or second eDP signal to a first display device through the first transmission cable after conversion is completed, and sending, by the second DP to eDP module, the first eDP signal or second eDP signal to a second display device through the second transmission cable after conversion is completed;
S7, decoding and processing, by a first display controller of the first display device, the first eDP signal or the second eDP signal after receiving it; sending decoded and processed image data to the first display panel; displaying, by the first display panel, received image data; decoding and processing, by a second display controller of the second display device, the first eDP signal or the second eDP signal after receiving it; sending decoded and processed image data to the second display panel; displaying, by second display panel, received image data.

In an embodiment of the present disclosure, in step S2, when the presence of a power supply signal at an audio interface has been detected by the detection module, the detection module determines that there is an audio device connected to the audio interface and generates a second detection result, which is then sent to the first microcontroller; the second detection result is then sent to the list display module by the first microcontroller; that the audio device has been successfully connected is learn by a user through the list display module; an audio signal is sent to the first lightning chip through a PCIe channel of the first lightning cable by the input device; the audio signal is then send to the audio device connected to the audio interface through the USB audio module by the first lightning chip and is played by the audio device.

In an embodiment of the present disclosure, in step S2, when the presence of a power supply signal at the USB interface is detected by the detection module, the detection module determines that a lightning external hard drive is connected to the USB interface and generates a third detection result, which is then sent to the first microcontroller; the third detection result is then sent to the list display module by the first microcontroller, that the lightning external hard drive has been successfully connected is learn by the user through the list display module; to-be-transmitted data is sent to the first lightning chip through the USB channel of the first lightning cable by the input device; the to-be-transmitted data is sent by the first lightning chip to the lightning external hard drive connected to the USB interface through the USB transmission module and stores it by the lightning external hard drive.

The beneficial effects of the present disclosure are:

The multi-screen display system has no delay and does not require an installation of a driver. A single motherboard can meet a need of multiple resolutions and high refresh screens. The first lightning chip of the control device can receive DP signals corresponding to same or different images, and the DP to eDP module can convert them into the same or different eDP signals for transmission to the first and second display devices. This enables the first display device and the second display device to achieve an effect of multi-screen simultaneous display or multi-screen different display. In addition, the first lightning chip of the control device uses lightning technology 3, which can reach a transmission rate of 40 Gbps, allowing the first and second display devices to have better clarity and smoothness of images.

### BRIEF DESCRIPTION OF DRAWINGS

FIG. 1 is a schematic diagram of an overall structure of a display system.

FIG. 2 is a schematic diagram of a structure of a control device of the display system.

FIG. 3 is a schematic diagram of a structure of a first display device of the display system.

FIG. 4 is a schematic diagram of a structure of a second display device of the display system.

FIG. 5 is a flowchart of a control method for a display system.

Numeral reference: 1. Control device; 2. First display device; 3. Second display device; 4. First microcontroller; 5. First lightning chip; 6. Detection module; 7. List display module; 8. First DP to eDP module; 9. Second DP to eDP module; 10. First display controller; 11. First display panel; 12. First backlight adjustment module; 13. Second display controller; 14. Second display panel; 15. Second backlight adjustment module; 16. First eDP interface; 17. Second eDP interface; 18. Third eDP interface; 19. Fourth eDP interface; 20. USB audio module; 21. Audio interface; 22. USB transmission module; 23. USB interface.

### DESCRIPTION OF EMBODIMENTS

The following will provide a clear and complete description of the technical solution in the embodiments of the present disclosure, in combination with the drawings. Obviously, the described embodiments are only a part of the embodiments of the present disclosure, not all of them. Based on the embodiments in the present disclosure, all other embodiments obtained by ordinary technicians in the art without creative work fall within the protection scope of the present disclosure.

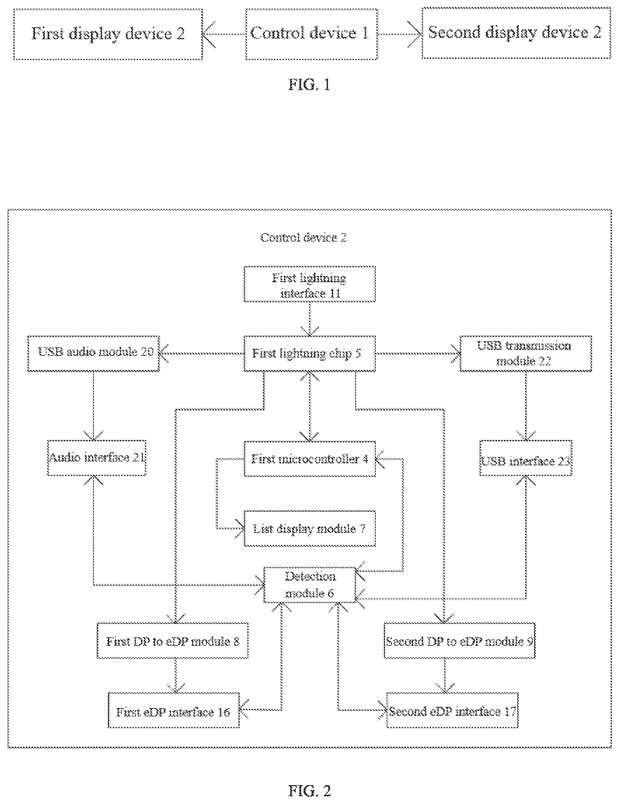

The present disclosure provides a multi-screen display system based on a lightning chip, as shown in combination with FIGS. 1 to 4. An input end of the multi-screen display system is connected to an input device, the multi-screen display system includes a control device 1, a first display device 2, and a second display device 3. The control device 1 is connected to the first display device 2 and the second display device 3, respectively. The control device 1 includes a first microcontroller 4 configured to receive a detection result sent by the detection module 6 and send it to a list display module 7. The first microcontroller 4 is connected to the detection module 6, the list display module 7, and the first lightning chip 5, respectively. The first lightning chip 5 is configured to receive DP signal sent by the input device through a first lightning cable, and output it in a format of DP signal to a first DP to eDP module 8 and a second DP to eDP module 9, respectively. The first lightning chip 5 is connected to the first DP to eDP module 8 and the second DP to eDP module 9 through a second lightning cable; the detection module 6 is configured to detect power supply signals of various interfaces of the control device 1 and generate the detection result to send to the first microcontroller 4 when the power supply signals of the interfaces change. The detection module 6 is connected to the first microcontroller 4. The list display module 7 is configured to display number and status of an external device that is currently connected to the control device 1, and is connected to the first microcontroller 4.

A lightning interface of the lightning chip supports high bandwidth data transmission, providing a transmission speed of up to 40 Gbps. This high-speed transmission renders it suitable for connecting high-performance peripherals such as high-resolution displays, external storage devices, and video capture devices. The lightning interface further supports simultaneous transmission of multiple protocols, including PCI Express, DisplayPort, and USB. This means that it can transmit data, video, and power simultaneously on a single connection, providing greater flexibility, allowing a user to power this device through a single lightning connection while transmitting data at high speeds, thereby reducing cable confusion, and providing a more convenient use experience. Based on this, a first lightning chip 5 of the control device 1 adopts a JHL7440 lightning chip, which enables the data of the input device to be transmitted at high speed to the first display device 2 and the second display device 3, which is conducive to achieving an effect of multi-screen simultaneous display or multi-screen different display in the multi-screen display system.

Meanwhile, the first DP to eDP module 8 and the second DP to eDP module 9 can use RTD2141 chip, IT6263 converter, or LT8668SXC chip. The RTD2141 chip is configured to perform protocol conversion from DP to eDP. The RTD2141 chip first receives the first DP signal, or the second DP signal sent from the first lightning chip 5, and then converts the first DP signal or the second DP signal into the first eDP signal or the second eDP signal that meets eDP standard. The RTD2141 chip also performs resolution adaptation at appropriate times, to ensure that output first eDP signal and second eDP signal match a resolution of the connected first display device 2 and second display device 3, processed first and second eDP signals are sent to the first display device through a first transmission cable or to the second display device through a second transmission cable. At this time, the user can see a corresponding video content on the first display device 2 and the second display device 3.

In addition, the first microcontroller 4 is connected to the detection module 6, the list display module 7, and the first lightning chip 5, respectively. The detection module 6 is connected to a first eDP interface 16, a second eDP interface 17, an audio interface 21, and a USB interface 23, and is configured to detect changes in power supply signal of the first eDP interface 16, the second eDP interface 17, the audio interface 21, and the USB interface 23. When an external device is connected to one of the first eDP interface 16, the second eDP interface 17, the audio interfaces 21 and USB interface 23, the power supply signal of the interface changes from “no signal” to “signal”. When the interface has a power supply signal, it indicates that an external device has successfully connected. The detection module 6 determines that the external device has successfully connected and generates a corresponding detection result to send to the first microcontroller 4. The first microcontroller 4 then sends the detection results to the list display module 7, which displays them, and the user can view a successfully connected device through the list display module 7; proving with the detection module in the multi-screen system is beneficial for the user to quickly view the successfully connected display devices or other external devices in the multi-screen display system, rendering it easier for the user to control the input device to transmit different data to the control device 1, and the control device 1 further sends the data to the display device for display.

In an optional implementation, as shown in a combination of FIGS. 1 and 2, the control device 1 further includes a first DP to eDP module 8, which is configured to receive the first DP signal sent by the first lightning chip 5 through the first DP channel of the second lightning cable and convert the first DP signal into the first eDP signal, a conversion includes adjusting data format, timing, and protocol. The first DP to eDP module 8 is connected to the first lightning chip 5 and a first eDP interface 16, respectively. The first eDP interface 16 is connected to the detection module 6. The second DP to eDP module 9 is configured to receive a second DP signal sent by the first lightning chip 5 through a second DP channel of the second lightning cable and convert the second DP signal into a second eDP signal, a conversion includes adjusting data format, timing, and protocol. The second DP to eDP module 9 is respectively connected to the first lightning chip 5 and the second eDP interface 17, and the second eDP interface 17 is connected to the detection module 6.

Where, eDP signal transmission has advantages of low power consumption and simplified cable design compared to DP signal transmission. Specifically, eDP signal transmission can be carried out through simpler cables, which helps simplify design and reduce device size. eDP considers power consumption optimization during design, especially being suitable for portable devices. Based on this, the control device 1 is provided with a first DP to eDP module 8 and a second DP to eDP module 9. The DP signal is converted into an eDP signal and then transmitted to reduce power consumption while ensuring compatibility between the control device 1, the first display device 2, and the second display device 3. By providing with the first DP to eDP module 8 that converts the first DP signal into the first eDP signal, thus, a compatibility between the control device 1 and the first display device 2 is ensured, so that the control device 1 and the first display device 2 can correctly exchange and display image signals. By providing with the second DP to eDP module 9 that converts the second DP signal into the second eDP signal, the compatibility between the control device 1 and the second display device 3 is ensured, thereby allowing the control device 1 and the second display device 3 to correctly exchange and display image signals.

In an optional embodiment, as shown in combination with FIGS. 1 and 3, the first display device 2 includes: a first display controller 10 configured to receive, decode, and process signals transmitted from the first eDP interface 16 of the control device 1 to a third eDP interface 18 of the first display device 2 through a first transmission cable, and decoded signal is transmitted to the first display panel 11. The third eDP interface 18 is connected to the first display controller 10. The first display controller 10 is connected to the first display panel 11. The first display panel 11 is configured to display image data decoded by the first display controller 10. A first backlight adjustment module 12 is configured to sense a light intensity of an external environment and can control the first display controller 10 to adjust a screen backlight brightness of the first display panel 11 based on the light intensity of the external environment. The first backlight adjustment module 12 is connected to the first display controller 10.

By setting the first display controller 10 to decode and process the signal transmitted through the first transmission cable to the first display device 2, the first display panel 11 can display image data corresponding to the signal transmitted by the control device 1. In addition, the first backlight adjustment module 12 set by the first display device 2 can self-sense an ambient light intensity during use, send an adjustment signal to the first display controller 10 based on the ambient light intensity, and then the first display controller 10 adjusts the screen backlight brightness of the first display panel 11.

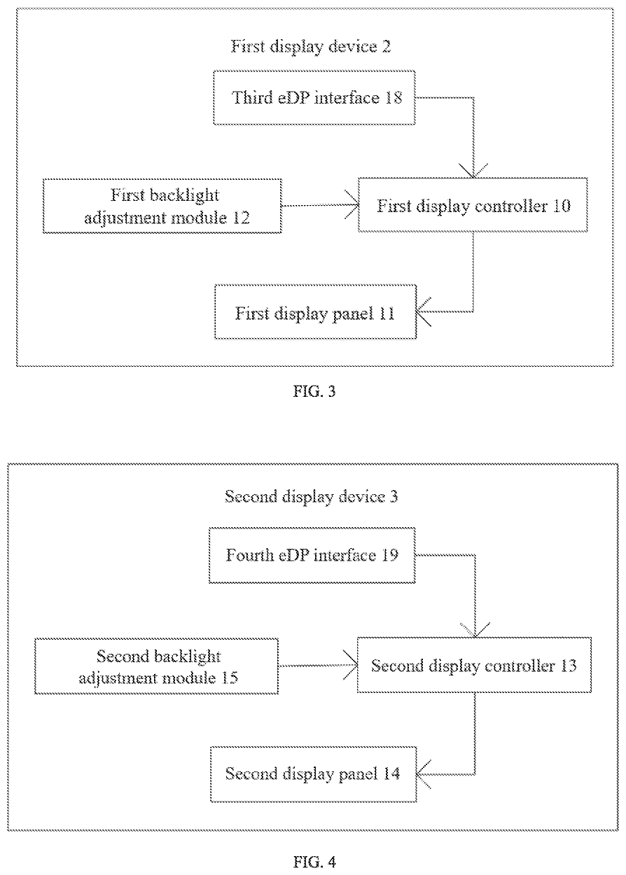

In an optional implementation, as shown in combination with FIGS. 1 and 4, the second display device 3 includes a second display controller 13 configured to receive, decode, and process signals transmitted from the second eDP interface 17 of the control device 1 to a fourth eDP interface 19 of the second display device 3 through a second transmission cable, and decoded signal is sent to the second display panel 14. The fourth eDP interface 19 is connected to the second display controller 13. The second display controller 13 is connected to the second display panel 14. The second display panel 14 is configured to display image data decoded by the second display controller 13. The second backlight adjustment module 15 is configured to sense the light intensity of the external environment and can control the second display controller 13 to adjust a screen backlight brightness of the second display panel 14 based on the light intensity of the external environment. The second backlight adjustment module 15 is connected to the second display controller 13.

By providing with the second display controller 13 that decodes and processes the signal transmitted through the second transmission cable to the second display device 3, the second display panel 14 can display image data corresponding to the signal transmitted by the control device 1. In addition, the second backlight adjustment module 15 set by the second display device 3 can self-sense the ambient light intensity during use, send an adjustment signal to the second display controller 13 based on the ambient light intensity, and then the second display controller 13 adjusts the screen backlight brightness of the second display panel 14.

In addition, the system is provided with a first display device 2 and a second display device 3, which can receive same or different eDP signals sent by the control device 1. When the first display device 2 and the second display device 3 receive same eDP signal, the first display device 2 and the second display device 3 display the same screen. When the first display device 2 and the second display device 3 receive different eDP signals, the first display device 2 and the second display device 3 display different screens, allowing the multi-screen display system to achieve an effect of multi-screen simultaneous display or multi-screen different display.

In an optional embodiment, as shown in the combination of FIGS. 1 and 2, the control device 1 further includes a USB audio module 20 configured to receive audio signals transmitted from an input device to the first lightning chip 5 through the first lightning cable, and transmit it to an audio device connected to the audio interface 21 through the audio interface 21. The USB audio module 20 is respectively connected to the first lightning chip 5 and the audio interface 21; the audio interface 21 is connected to the detection module 6. The USB transmission module 22 is configured to receive data transmitted from the input device to the first lightning chip 5 through the first lightning cable, and transmit it to an external device connected to the USB interface 23 through the USB interface 23. The USB transmission module 22 is respectively connected to the first lightning chip 5 and USB interface 23, and the USB interface 23 is connected to the detection module 6.

When an external device is connected through audio interface 21 or USB interface 23, the detection module 6 detects that power supply signal of audio interface 21 or USB interface 23 changes from “no signal” to “signal”. The detection module 6 determines that the external device is successfully connected and generates a second or third detection result to send to the first microcontroller 4. The first microcontroller 4 then sends second or third detection result to the list display module 7 for display, the user can know the number and status of successfully connected devices through the list display module 7, in order to transmit different signals to the multi-screen connection system through input devices connected to the multi-screen display system.

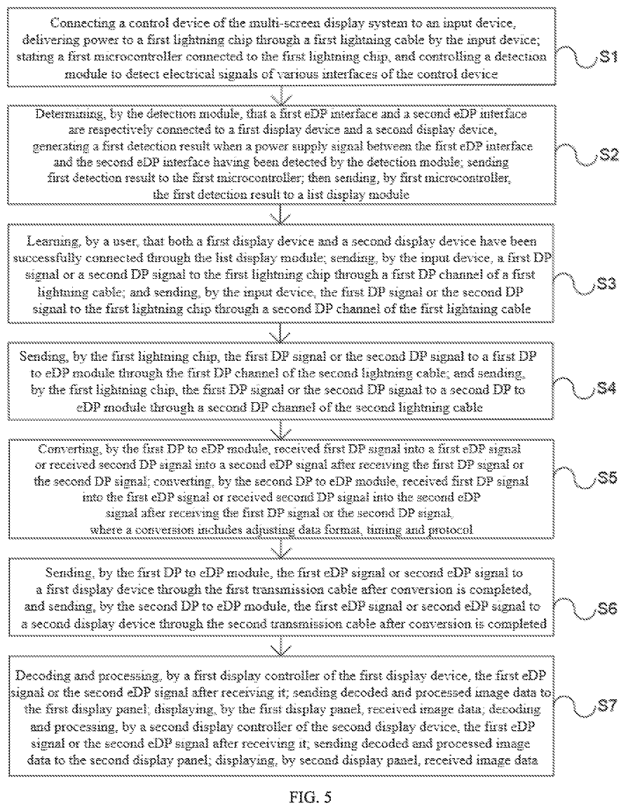

The present disclosure further discloses a control method for a multi-screen display system based on a lightning chip, which is configured to control the multi-screen display system, as shown in FIG. 5, and includes the following steps:
S1. connecting a control device of the multi-screen display system to an input device, delivering power to a first lightning chip through a first lightning cable by the input device; stating a first microcontroller connected to the first lightning chip, and controlling a detection module to detect electrical signals of various interfaces of the control device;
S2. determining, by the detection module, that a first eDP interface and a second eDP interface are respectively connected to a first display device and a second display device, generating a first detection result when a power supply signal between the first eDP interface and the second eDP interface having been detected by the detection module; sending first detection result to the first microcontroller; then sending, by first microcontroller, the first detection result to a list display module;
S3, learning, by a user, that both a first display device and a second display device have been successfully connected through the list display module; sending, by the input device, a first DP signal or a second DP signal to the first lightning chip through a first DP channel of a first lightning cable; and sending, by the input device, the first DP signal or the second DP signal to the first lightning chip through a second DP channel of the first lightning cable;
S4, sending, by the first lightning chip, the first DP signal or the second DP signal to a first DP to eDP module through the first DP channel of the second lightning cable; and sending, by the first lightning chip, the first DP signal or the second DP signal to a second DP to eDP module through a second DP channel of the second lightning cable;
S5, converting, by the first DP to eDP module, received first DP signal into a first eDP signal or received second DP signal into a second eDP signal after receiving the first DP signal or the second DP signal; converting, by the second DP to eDP module, received first DP signal into the first eDP signal or received second DP signal into the second eDP signal after receiving the first DP signal or the second DP signal, where a conversion includes adjusting data format, timing and protocol;
S6, sending, by the first DP to eDP module, the first eDP signal or second eDP signal to a first display device through the first transmission cable after conversion is completed, and sending, by the second DP to eDP module, the first eDP signal or second eDP signal to a second display device through the second transmission cable after conversion is completed;
S7, decoding and processing, by a first display controller of the first display device, the first eDP signal or the second eDP signal after receiving it; sending decoded and processed image data to the first display panel; displaying, by the first display panel, received image data; decoding and processing, by a second display controller of the second display device, the first eDP signal or the second eDP signal after receiving it; sending decoded and processed image data to the second display panel; displaying, by second display panel, received image data.

In an optional implementation mode, as shown in FIG. 5, in step S2, when the presence of a power supply signal at an audio interface has been detected by the detection module, the detection module determines that there is an audio device connected to the audio interface and generates a second detection result, which is then sent to the first microcontroller; the second detection result is then sent to the list display module by the first microcontroller; that the audio device has been successfully connected is learn by a user through the list display module; an audio signal is sent to the first lightning chip through a PCIe channel of the first lightning cable by the input device; the audio signal is then send to the audio device connected to the audio interface through the USB audio module by the first lightning chip and is played by the audio device.

In an optional implementation mode, as shown in FIG. 5, in step S2, when the presence of a power supply signal at the USB interface is detected by the detection module, the detection module determines that a lightning external hard drive is connected to the USB interface and generates a third detection result, which is then sent to the first microcontroller; the third detection result is then sent to the list display module by the first microcontroller, that the lightning external hard drive has been successfully connected is learn by the user through the list display module; to-be-transmitted data is sent to the first lightning chip through the USB channel of the first lightning cable by the input device; the to-be-transmitted data is sent by the first lightning chip to the lightning external hard drive connected to the USB interface through the USB transmission module and stores it by the lightning external hard drive.

In addition, it should be understood that although the specification is described according to the implementation modes, not each implementation mode only includes an independent technical solution. This description in the specification is for clarity only. Those skilled in the art should consider the specification as a whole, and the technical solutions in each embodiment can be appropriately combined to form other embodiment that those skilled in the art can understand.

What is claimed is:

1. A multi-screen display system based on a lightning chip, wherein an input end of the multi-screen display system is connected to an input device, the multi-screen display system comprises a control device (1), a first display device (2), and a second display device (3); the control device (1) is connected to the first display device (2) and the second display device (3), respectively;
wherein the control device (1) comprises:
a first microcontroller (4) configured to receive a detection result sent by a detection module (6) and send it to a list display module (7), the first microcontroller (4) is connected to the detection module (6), the list display module (7), and a first lightning chip (5), respectively;
the first lightning chip (5) configured to receive DP signal sent by the input device through a first lightning cable, and outputs it in a format of DP signal to a first DP to eDP module (8) and a second DP to eDP module (9), respectively; the first lightning chip (5) is connected to the first DP to eDP module (8) and the second DP to eDP module (9) through a second lightning cable;
the detection module (6) configured to detect power supply signals of various interfaces of the control device (1), generate the detection result when the power supply signals of the interfaces change, and send to the first microcontroller (4), the detection module (6) is connected to the first microcontroller (4);
the list display module (7) configured to display number and status of an external device that is currently connected to the control device (1), the list display module (7) is connected to the first microcontroller (4).

2. The multi-screen display system based on a lightning chip according to claim 1, wherein the control device (1) further comprises the first DP to eDP module (8) and the second DP to eDP module (9);
the first DP to eDP module (8) is configured to receive a first DP signal sent by the first lightning chip (5) through a first DP channel of the second lightning cable and convert the first DP signal into a first eDP signal, wherein a conversion comprises adjusting data format, timing, and protocol; the first DP to eDP module (8) is connected to the first lightning chip (5) and a first eDP interface (16), respectively; the first eDP interface (16) is connected to the detection module (6);
the second DP to eDP module (9) is configured to receive a second DP signal sent by the first lightning chip (5) through a second DP channel of the second lightning cable and convert the second DP signal into a second eDP signal, wherein a conversion comprises adjusting data format, timing, and protocol; the second DP to eDP module (9) is connected to the first lightning chip (5) and a second eDP interface (17), respectively; the second eDP interface (17) is connected to the detection module (6).

3. The multi-screen display system based on a lightning chip according to claim 1, wherein the first display device (2) comprises a first display controller (10), a first display panel (11), and a first backlight adjustment module (12);
the first display controller (10) is configured to receive, decode, and process signals transmitted from the first eDP interface (16) of the control device (1) to a third eDP interface (18) of the first display device (2) through a first transmission cable, and sends decoded signal to the first display panel (11), the third eDP interface (18) is connected to the first display controller (10); the first display controller (10) is connected to the first display panel (11);
the first display panel (11) is configured to display image data decoded by the first display controller (10);
the first backlight adjustment module (12) is configured to sense a light intensity of an external environment and control the first display controller (10) to adjust a screen backlight brightness of the first display panel (11) based on light intensity of the external environment; the first backlight adjustment module (12) is connected to the first display controller (10).

4. The multi-screen display system based on a lightning chip according to claim 1, wherein the second display device (3) comprises a second display controller (13), a second display panel (14), and a second backlight adjustment module (15);
the second display controller (13) is configured to receive, decode, and process signals transmitted from the second eDP interface (17) of the control device (1) to a fourth eDP interface (19) of the second display device (3) through a second transmission cable, and send decoded signal to the second display panel (14), the fourth eDP interface (19) is connected to the second display controller (13); the second display controller (13) is connected to the second display panel (14);
the second display panel (14) is configured to display image data decoded by the second display controller (13);
the second backlight adjustment module (15) is configured to sense the light intensity of the external environment and control the second display controller (13) to adjust a screen backlight brightness of the second display panel (14) based on the light intensity of the external environment; the second backlight adjustment module (15) is connected to the second display controller (13).

5. The multi-screen display system based on a lightning chip according to claim 1, wherein the control device (1) further comprises a USB audio module (20) and a USB transmission module (22);
the USB audio module (20) is configured to receive an audio signal transmitted from the input device to the first lightning chip (5) through the first lightning cable, and transmit it to an audio device connected to the audio interface (21) through an audio interface (21); the USB audio module (20) is respectively connected to the first lightning chip (5) and the audio interface (21); the audio interface (21) is connected to the detection module (6);
the USB transmission module (22) is configured to receive data transmitted from the input device to the first lightning chip (5) through the first lightning cable, and transmit it to an external device connected to the USB interface (23) through the USB interface (23); the USB transmission module (22) is respectively connected to the first lightning chip (5) and the USB interface (23), and the USB interface (23) is connected to the detection module (6).

6. A control method for a multi-screen display system based on a lightning chip, wherein the control method is configured to control the multi-screen display system according to claim 1, and the control method comprises the following steps:
S1. connecting a control device of the multi-screen display system to an input device, delivering power to a first lightning chip through a first lightning cable by the input device; stating a first microcontroller connected to the first lightning chip, and controlling a detection module to detect electrical signals of various interfaces of the control device;
S2. determining, by the detection module, that a first eDP interface and a second eDP interface are respectively connected to a first display device and a second display device, generating a first detection result when a power supply signal between the first eDP interface and the second eDP interface having been detected by the detection module; sending first detection result to the first microcontroller; then sending, by first microcontroller, the first detection result to a list display module;
S3, learning, by a user, that both a first display device and a second display device have been successfully connected through the list display module; sending, by the input device, a first DP signal or a second DP signal to the first lightning chip through a first DP channel of a first lightning cable; and sending, by the input device, the first DP signal or the second DP signal to the first lightning chip through a second DP channel of the first lightning cable;
S4, sending, by the first lightning chip, the first DP signal or the second DP signal to a first DP to eDP module through the first DP channel of the second lightning cable; and sending, by the first lightning chip, the first DP signal or the second DP signal to a second DP to eDP module through a second DP channel of the second lightning cable;
S5, converting, by the first DP to eDP module, received first DP signal into a first eDP signal or received second DP signal into a second eDP signal after receiving the first DP signal or the second DP signal; converting, by the second DP to eDP module, received first DP signal into the first eDP signal or received second DP signal into the second eDP signal after receiving the first DP signal or the second DP signal, wherein a conversion comprises adjusting data format, timing and protocol;
S6, sending, by the first DP to eDP module, the first eDP signal or second eDP signal to a first display device through the first transmission cable after conversion is completed, and sending, by the second DP to eDP module, the first eDP signal or second eDP signal to a second display device through the second transmission cable after conversion is completed;
S7, decoding and processing, by a first display controller of the first display device, the first eDP signal or the second eDP signal after receiving it; sending decoded and processed image data to the first display panel; displaying, by the first display panel, received image data; decoding and processing, by a second display controller of the second display device, the first eDP signal or the second eDP signal after receiving it; sending decoded and processed image data to the second display panel; displaying, by second display panel, received image data.

7. The control method for a multi-screen display system based on a lightning chip according to claim 6, wherein in S2, when the presence of a power supply signal at an audio interface has been detected by the detection module, the detection module determines that there is an audio device connected to the audio interface and generates a second detection result, which is then sent to the first microcontroller; the second detection result is then sent to the list display module by the first microcontroller; that the audio device has been successfully connected is learn by a user through the list display module; an audio signal is sent to the first lightning chip through a PCIe channel of the first lightning cable by the input device; the audio signal is then send to the audio device connected to the audio interface through the USB audio module by the first lightning chip and is played by the audio device.

8. The control method for a multi-screen display system based on a lightning chip according to claim 6, wherein in S2, when the presence of a power supply signal at the USB interface is detected by the detection module, the detection module determines that a lightning external hard drive is connected to the USB interface and generates a third detection result, which is then sent to the first microcontroller; the third detection result is then sent to the list display module by the first microcontroller, that the lightning external hard drive has been successfully connected is learn by the user through the list display module; to-be-transmitted data is sent to the first lightning chip through the USB channel of the first lightning cable by the input device; the to-be-transmitted data is sent by the first lightning chip to the lightning external hard drive connected to the USB interface through the USB transmission module and stores it by the lightning external hard drive.
